(19) United States
(12) Patent Application Publication
(10) Pub. No.: US 2026/0204818 A1
(43) Pub. Date: Jul. 16, 2026

(54) Plastic Board Connection Structure

(71) Applicant: Ningbo Luhai Bojiang Leisure Products Co., Ltd., Zhejiang (CN)

(72) Inventor: Yuan LIU, Henan (CN)

(73) Assignee: Ningbo Luhai Bojiang Leisure Products Co., Ltd., Zhejiang (CN)

(21) Appl. No.: 19/537,619

(22) Filed: Feb. 12, 2026

(30) Foreign Application Priority Data
Apr. 14, 2025 (CN) 2025206961792

(51) Int. Cl. H01R 12/71; H01R 12/52; H01R 13/405; H01R 13/41; H01R 13/514; H01R 13/629; H01R 13/6585

(52) U.S. Cl. CPC H01R 12/716; H01R 12/52; H01R 13/405; H01R 13/41; H01R 13/514; H01R 13/629; H01R 13/6585

(57) ABSTRACT

The present disclosure relates to a plastic board connection structure, comprising a first plastic board and a second plastic board, which are separately arranged; the first plastic board has a first end close to the second plastic board and a second end away from the second plastic board; the second plastic board has a first end away from the first plastic board and a second end close to the first plastic board; the plastic board connection structure further includes a connector arranged on the back sides of the first plastic board and the second plastic board, the connector being detachably connected to the back side of the first plastic board and detachably connected to the back side of the second plastic board; after the connector is removed, the first plastic board can be stacked with the second plastic board, thereby completing folding to reduce the packaging volume.

### CROSS-REFERENCE TO RELATED APPLICATIONS

This application claims priority to Chinese Utility Model Patent Application No. 202520696179.2, filed on April 14, 2025, entitled " Plastic Board Connection Structure", the content of which, including the amendments thereof, is incorporated herein by reference in its entirety.

### TECHNICAL FIELD

The present disclosure relates to the technical field of plastic boards, particularly to a plastic board connection structure.

### BACKGROUND

Plastic products are widely used in contemporary society. Many products, such as American-style tool sheds, outdoor houses, storage boxes, plastic ladders, plastic stools, and the like are constructed by splicing plastic boards. This type of splicing structure offers advantages such as flexible assembly, high production efficiency, and relatively light overall weight, making it commonly used in civil, industrial, and storage fields.

Currently, in the manufacturing and assembly processes of related products, the plastic boards used are mostly large-area monolithic panels. While this design ensures the structural strength and integrity after assembly, it has obvious shortcomings in packaging, storage, and transportation. Especially for large products like American-style tool sheds and outdoor houses, the required plastic boards are often very large in size, resulting in bulky single panels that occupy significant space. This not only increases transportation costs but also poses difficulties in handling, stacking, and protection during logistics. Furthermore, large-sized panels are prone to bending, scratching, or local damage during transportation, affecting product quality and user experience.

### SUMMARY

The present disclosure provides a plastic board connection structure to solve the problems raised in the above background art.

To achieve the above object, the present disclosure adopts the following technical solution:

A plastic board connection structure includes a first plastic board and a second plastic board. The first plastic board and the second plastic board are separately arranged; the first plastic board has a first end close to the second plastic board and a second end away from the second plastic board; the second plastic board has a first end away from the first plastic board and a second end close to the first plastic board, with the first end of the first plastic board and the second end of the second plastic board facing each other; the plastic board connection structure further comprises a connector arranged on a back side of the first plastic board and a back side of the second plastic board, the connector being detachably connected to the back side of the first plastic board and detachably connected to the back side of the second plastic board, the connector spanning the first end of the first plastic board and the second end of the second plastic board, thereby connecting the first plastic board and the second plastic board into a tiled plate; and after the connector is removed, the first plastic board is capable of being stacked with the second plastic board, thereby completing folding to reduce a packaging volume.

The beneficial effects of the present disclosure compared to the prior art are as follows:

By replacing the traditional large-size monolithic plastic board with a detachable, split design, the plastic board can be folded and stacked before transportation, effectively reducing packaging volume and floor space, significantly lowering logistics costs and requirements for handling space, while also minimizing the risk of damage such as bending and scratching during transit due to oversized panels; using detachable connectors (such as connecting rods or pinch plates) to span splicing areas, combined with positioning slots, buckles, or fasteners to achieve secure locking, ensures that the split boards form a smooth, continuous overall surface after installation, maintaining the necessary structural strength, integrity, and flatness for wall panels, partitions and the like; this connection structure facilitates the expansion and splicing of a plurality of plastic boards in both horizontal and vertical directions, enabling efficient assembly into structural units like walls or partitions for buildings such as tool sheds or outdoor rooms, achieving rapid modular assembly while preserving overall stability and sealing of the structure; the detachable connectors allow the plastic boards to be separated and folded again when needed, facilitating storage, movement, or replacement of locally damaged panels, extending product lifespan and reducing maintenance difficulty.

### BRIEF DESCRIPTIONOF DRAWINGS

The drawings, which form a part of this application, are provided to further illustrate the present disclosure. The illustrative embodiments and descriptions thereof are intended to explain the present disclosure and do not constitute an undue limitation thereof. In the drawings:

FIG. 1 is a schematic structural diagram of the first plastic board and the second plastic board in an unfolded state.

FIG. 2 is a cross-sectional view taken along line A-A of FIG. 1.

FIG. 3 is a partial enlarged view of section A in FIG. 2.

FIG. 4 is a cross-sectional view taken along line B-B of FIG. 1.

FIG. 5 is a partial enlarged view of section B in FIG. 4.

FIG. 6 is an exploded schematic diagram of the first plastic board and the second plastic board in an unfolded state.

FIG. 7 is a schematic structural diagram of a clip serving as a buckle.

FIG. 8 is a schematic diagram of the back side of the first plastic board.

FIG. 9 is a partial enlarged view of section C in FIG. 8.

FIG. 10 is a schematic structural diagram of a connecting rod.

FIG. 11 is a schematic structural diagram of the first plastic board and the second plastic board in a folded state.

FIG. 12 is a longitudinal cross-sectional view of FIG. 11.

FIG. 13 is a perspective schematic diagram of another embodiment of the connector of the present disclosure.

FIG. 14 is an exploded schematic view of FIG. 13.

FIG. 15 is a perspective schematic view of another embodiment of the connector of the present disclosure.

FIG. 16 is an exploded schematic view of FIG. 15.

### DESCRIPTION OF EMBODIMENTS

The technical solutions in the embodiments of the present disclosure will be clearly and completely described below with reference to the accompanying drawings in the embodiments of the present disclosure. It is apparent that the described embodiments are only a part of the embodiments of the present disclosure, rather than all of them. The following description of at least one exemplary embodiment is illustrative only and is in no way intended to limit the present disclosure and its applications or uses. Based on the embodiments of the present disclosure, all other embodiments obtained by those of ordinary skill in the art without creative efforts shall fall within the scope of protection of the present disclosure.

It should be noted that the terms used herein are only for describing specific embodiments and are not intended to limit the exemplary embodiments according to the present application. As used herein, unless the context clearly indicates otherwise, the singular forms are intended to include the plural forms as well. Furthermore, it should be understood that when the terms "comprise" and/or "include" are used in this specification, they indicate the presence of features, steps, operations, devices, components, and/or combinations thereof.

Unless specifically stated otherwise, the relative arrangement, numerical expressions, and numerical values of components and steps set forth in these embodiments do not limit the scope of the present disclosure. At the same time, it should be understood that for ease of description, the dimensions of the various parts shown in the drawings are not drawn according to actual proportional relationships. Techniques, methods, and equipment known to those of ordinary skill in the relevant art may not be discussed in detail, but where appropriate, such teclmiques, methods, and equipment should be considered as part of the authorized specification. In all examples shown and discussed herein, any specific values should be construed as illustrative only and not as limiting. Therefore, other examples of the exemplary embodiments may have different values. It should be noted that similar reference numerals and letters denote similar items in the following drawings, so once an item is defined in one drawing, it does not need to be further discussed in subsequent drawings.

In the present disclosure, addressing the technical issues of large volume, high space occupation, elevated costs, and susceptibility to bending or damage during logistics in existing large plastic products (such as tool sheds, outdoor sheds) that use monolithic large-sized plastic boards, a plastic board connection structure is provided. It includes separately arranged first and second plastic boards, and a detachable connector disposed on their back sides; wherein, by spanning and connecting the opposing ends of the two plastic boards through the detachable connector, they can be fixedly joined into a flat laying board during use, ensuring structural strength and integrity; by detaching the connector, the first and second plastic boards are allowed to overlap each other in various ways, thereby significantly reducing the overall packaging volume of the product, facilitating handling and transportation, and effectively lowering logistics costs and damage risks. Below, specific embodiments of the plastic board connection structure of the present disclosure are described in detail with reference to the drawings.

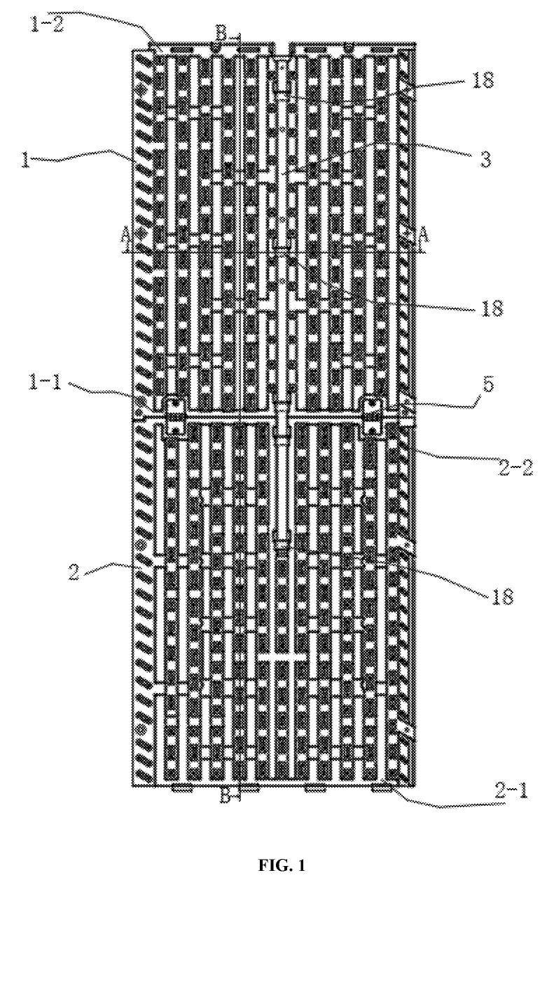

As shown in FIG. 1, the present disclosure provides a plastic board connection structure, including a first plastic board 1 and a second plastic board 2. Here, the first plastic board 1 and the second plastic board 2 are arranged separately. The separate arrangement of the first plastic board 1 and the second plastic board 2 means that the first plastic board 1 and the second plastic board 2 are two separate boards, which can be connected by means such as bolt fastening, hinge fastening and pin fastening, or in other embodiments, the first plastic board 1 and the second plastic board 2 may not be connected to each other.

The first plastic board 1 has a first end 1-1 close to the second plastic board 2 and a second end 1-2 away from the second plastic board 2. The second plastic board 2 has a first end 2-1 away from the first plastic board 1 and a second end 2-2 close to the first plastic board 1. The first end 1-1 of the first plastic board and the second end 2-2 of the second plastic board are arranged opposite each other, preferably directly facing each other. In other embodiments, the first end 1-1 of the first plastic board and the second end 2-2 of the second plastic board may be arranged opposite each other in a staggered manner.

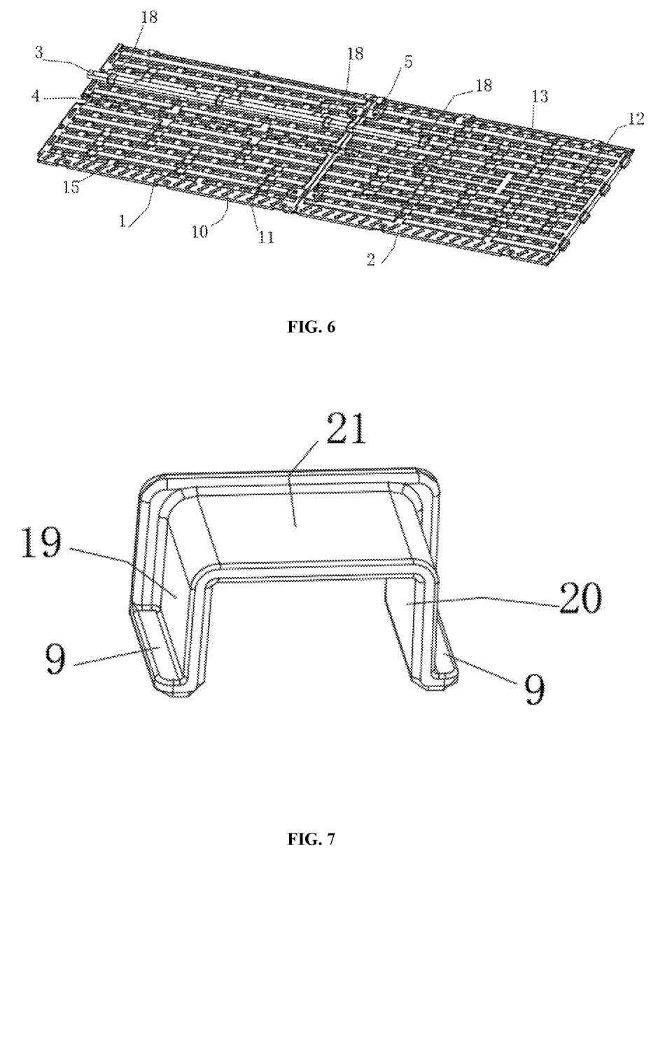

As shown in FIGS. 1 and 6, the plastic board connection structure also includes a connector 3 arranged on the back side of the first plastic board 1 and the back side of the second plastic board 2. The connector 3 is detachably connected to the back side of the first plastic board 1 and detachably connected to the back side of the second plastic board 2. The connector 3 spans the first end 1-1 of the first plastic board and the second end 2-2 of the second plastic board, thereby connecting the first plastic board I and the second plastic board 2 into a tiled plate. Preferably, the connector 3 can be configured as follows: both the back side of the first plastic board 1 and the back side of the second plastic board 2 have positioning slots 4, and the connector 3 is located in the positioning slots 4. During assembly, the connector 3 is first placed into the positioning slots 4 to achieve preliminary positioning, followed by the next step of detachable connection. In this embodiment, the connector 3 is vertically arranged on the back side of the first plastic board 1 and the back side of the second plastic board 2. The vertically arranged connector 3 can better and more stably fix the oppositely arranged first plastic board 1 and second plastic board 2, especially when the first end 1-1 of the first plastic board and the second end 2-2 of the second plastic board are directly opposite each other.

In the present disclosure, the connector 3 is preferably at least tightly attached at the first end 1-1 of the first plastic board and the second end 2-2 of the second plastic board to achieve a better connection effect. Specifically, the entire connector 3 is closely attached to the back side of the first plastic board 1 and the back side of the second plastic board 2, making the connection between the first plastic board 1 and the second plastic board 2 more stable.

As shown in FIGS. 6 and 11, after the connector 3 is removed, the first plastic board 1 can be stacked with the second plastic board 2 to complete folding and reduce packaging volume. The stacking method can be with the back side of the first plastic board 1 against the back side of the second plastic board 2, the front side of the first plastic board 1 against the front side of the second plastic board 2, the back side of the first plastic board 1 against the front side of the second plastic board 2, or the front side of the first plastic board 1 against the back side of the second plastic board 2. The situation shown in the FIG. is the back side of the first plastic board 1 stacked against the back side of the second plastic board 2.

In a preferred embodiment of the present disclosure, the contour of the first plastic board 1 is substantially the same as that of the second plastic board 2, so that when the first plastic board 1 and the second plastic board 2 are folded together, they substantially completely overlap, with the first plastic board 1 not extending beyond the second plastic board 2, and the second plastic board 2 not extending beyond the first plastic board 1, thereby further reducing the packaging volume after the first plastic board 1 and the second plastic board 2 are folded.

Since the first plastic board I and the second plastic board 2 are connected into a tiled plate by a connector 3, the separate arrangement of the first plastic board 1 and the second plastic board 2, as mentioned earlier, means they are two separate boards. The first end 1-1 of the first plastic board and the second end 2-2 of the second plastic board may not be connected to each other and can simply abut directly; alternatively, the first end 1-1 of the first plastic board and the second end 2-2 of the second plastic board may be hinged together, which does not affect the folding of the first plastic board 1 and the second plastic board 2. Specifically, a hinge 5 can be used to hinge the first end 1-1 of the first plastic board to the second end 2-2 of the second plastic board.

To achieve a substantially stable connection and fixation effect, the connector 3 is configured such that its extension length from the first end 1-1 to the second end 1-2 of the first plastic board is at least 1/4 of the length from the first end 1-1 to the second end 1-2 of the first plastic board; the extension length of the connector 3 from the second end 2-2 to the first end 2-1 of the second plastic board is at least 1/4 of the length from the second end 2-2 to the first end 2-1 of the second plastic board.

In one embodiment, the connector 3 extends from the first end 1-1 of the first plastic board to a position adjacent to the second end 1-2 of the first plastic board, and the end of the connector 3 adjacent to the second end 1-2 of the first plastic board is provided with a connection cavity, allowing the connection cavity at the end of the connector 3 to connect with other components.

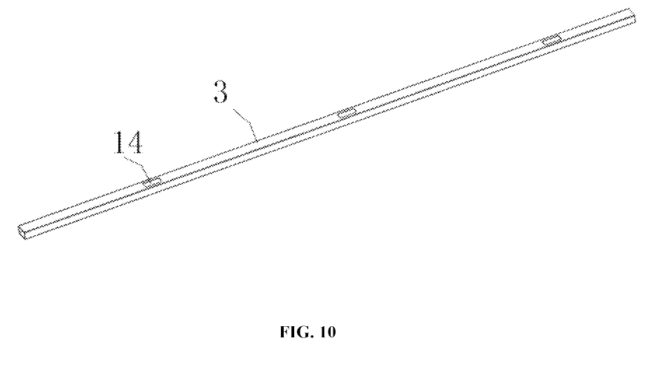

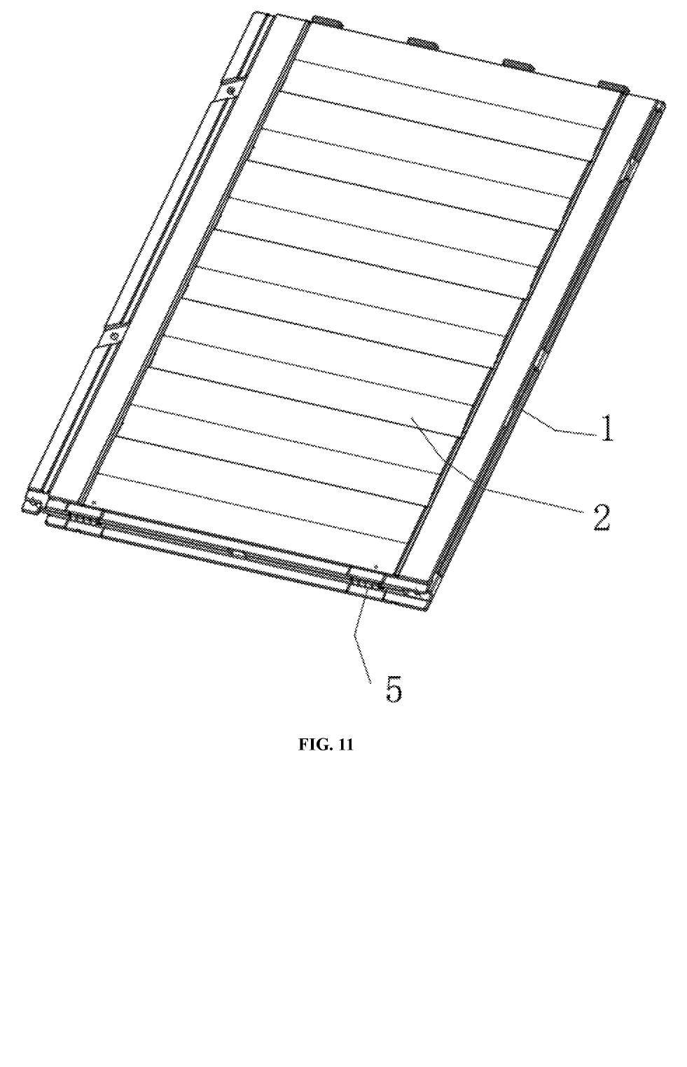

As a preferred form, referring to FIGS. 6 and 10, the connector 3 is a connecting rod, configured as a metal rod to maintain strong support strength and form stable support. The connecting rod is connected to the first plastic board 1 and the second plastic board 2 through detachable fasteners; to remove the connecting rod, simply detach the fasteners.

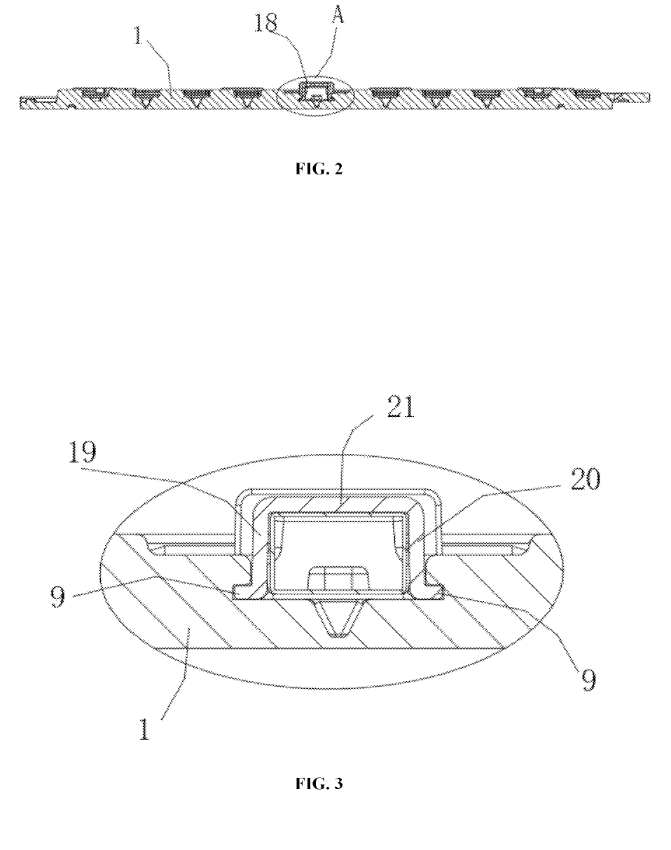

Please also refer to FIGS. 2, 3, 6, 7, and 9. In one embodiment, the fastener is several buckles, which snap onto the connecting rod and buckle-connect with the first plastic board 1 and the second plastic board 2. The specific buckle connection structure is preferably as follows: the back side of the first plastic board 1 and the back side of the second plastic board 2 are both provided with snap grooves 6, with baffle plates 7 on both sides of each snap groove 6, foring an interlayer 8 between the baffle plates 7 and the bottom surface of the snap groove 6; the buckle is configured as a clip 18 with an opening, and the connecting rod is clamped in the clip 18; the two outer sides of the clip 18 are provided with locking wings 9, which slide into the interlayer 8 so that the locking wings 9 are locked into the interlayer 8, thereby locking the connecting rod to the first plastic board 1 and the second plastic board 2.

In one embodiment of the present disclosure, the cross-section of the connecting rod is rectangular; the clip 18 includes a first side clamping plate 19, a second side clamping plate 20, and a bottom plate 21 connecting the first side clamping plate 19 and the second side clamping plate 20, with the connecting rod clamped in the clamping port formed by the first side clamping plate l 9, the second side clamping plate 20, and the bottom plate 21; the locking wings 9 are respectively provided on the outer side of the first side clamping plate 19 and the outer side of the second side clamping plate 20. This structural form of the clip can better adapt to a connecting rod with a rectangular cross-section while more effectively locking the connecting rod to the first plastic board 1 and the second plastic board 2.

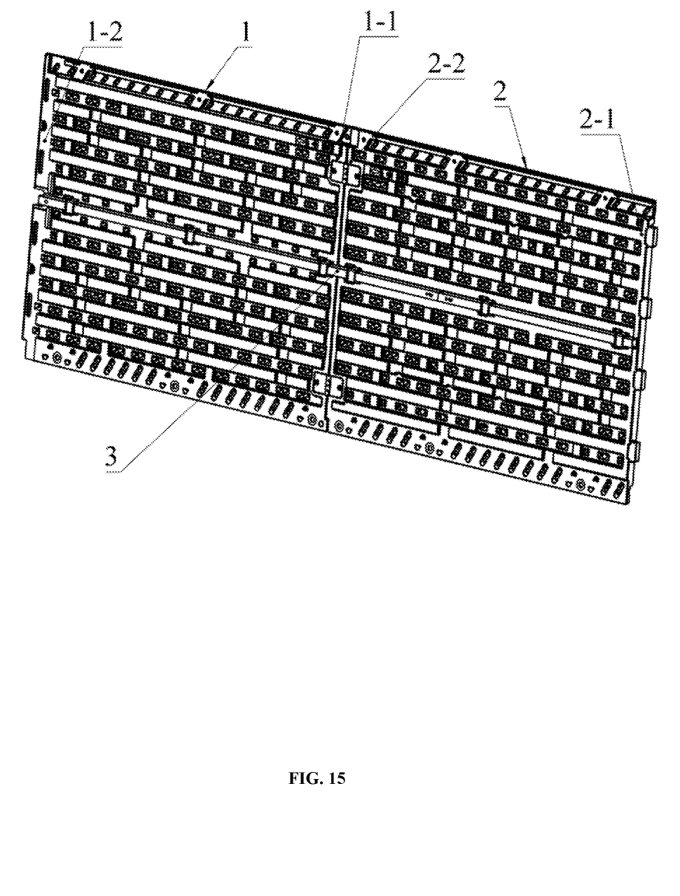

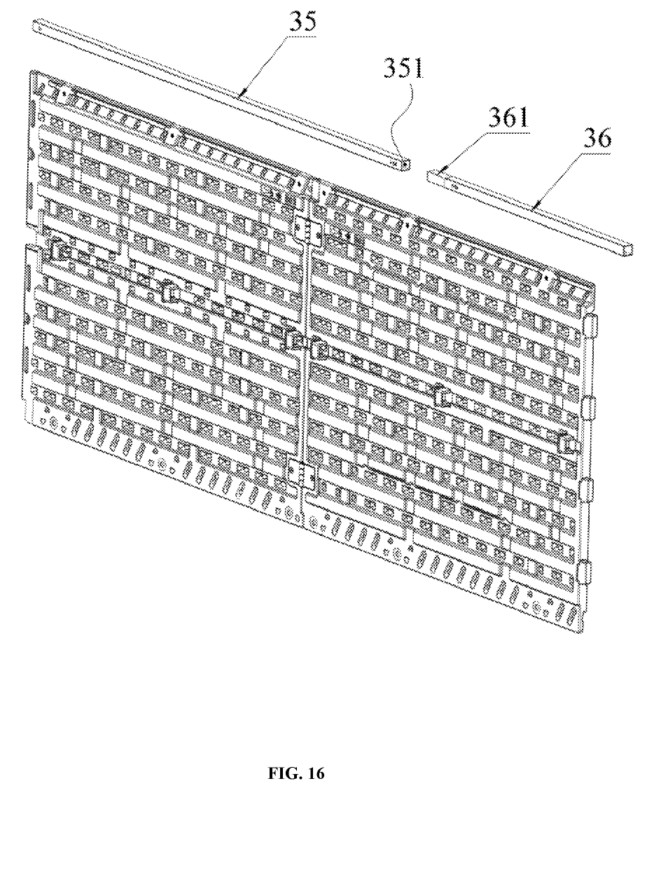

As shown in FIGS. 15 and 16, in another embodiment, to further enhance the overall stiffness and anti-warping performance of the board surface in the unfolded state, the connector 3 can also be configured as a through-type long connector, which is arranged along the length direction of the first plastic board 1 and the second plastic board 2. Further, the connector 3 is a sleeve-type steel tube structure, including two detachably fitted steel tubes, namely a first steel tube 35 and a second steel tube 36; the first steel tube 35 and the second steel tube 36 are preferably hollow profiles (e.g., square or rectangular tubes) to balance bending and torsional performance. One end of the first steel tube 35 forms a socket cavity 351 extending along its axial direction, and the second steel tube 36 has an insertion end 361 adapted to the socket cavity 351; during assembly, the insertion end 361 of the second steel tube 36 is inserted axially into the socket cavity 351 of the first steel tube 35, so that the two steel tubes form a predetermined overlap length axially, thereby constituting an integral through-type long connector in the assembled state. In the assembled state, this connector 3 not only spans the splicing area between the first end 1-1 of the first plastic board 1 and the second end 2-2 of the second plastic board 2, but also extends further to both sides, with one end extending to a position adjacent to the second end 1-2 of the first plastic board 1 and the other end extending to a position adjacent to the first end 2-1 of the second plastic board 2, thus forming a long- span constraint on the two plastic boards, suppressing relative warping, twisting, or misalignment at the splice and across the board bodies. During folding and storage, the first steel tube 35 and the second steel tube 36 can be disassembled first, separating them to reduce the single-piece length of the connector 3, facilitating co-storage with the plastic boards.

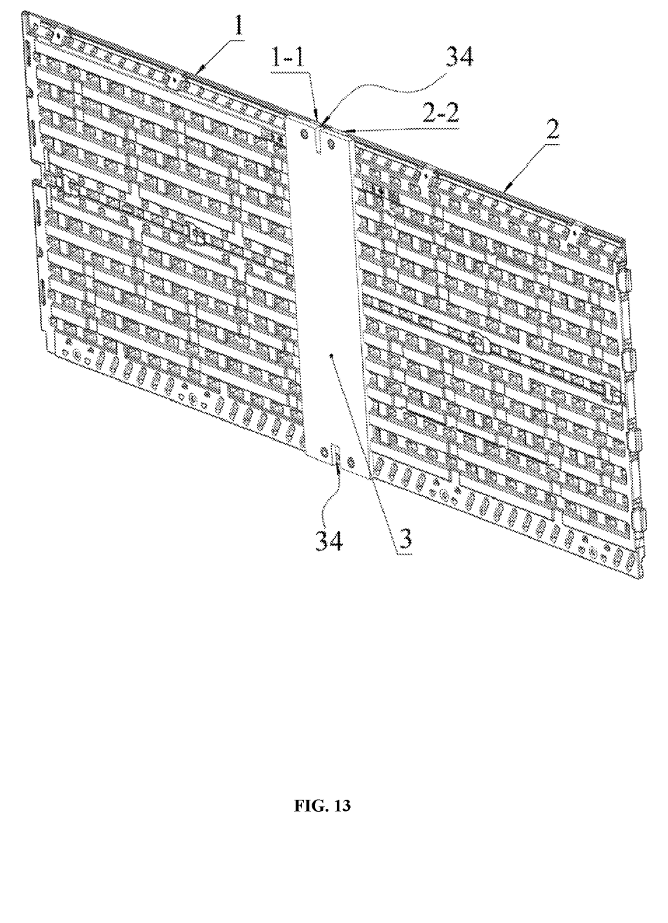

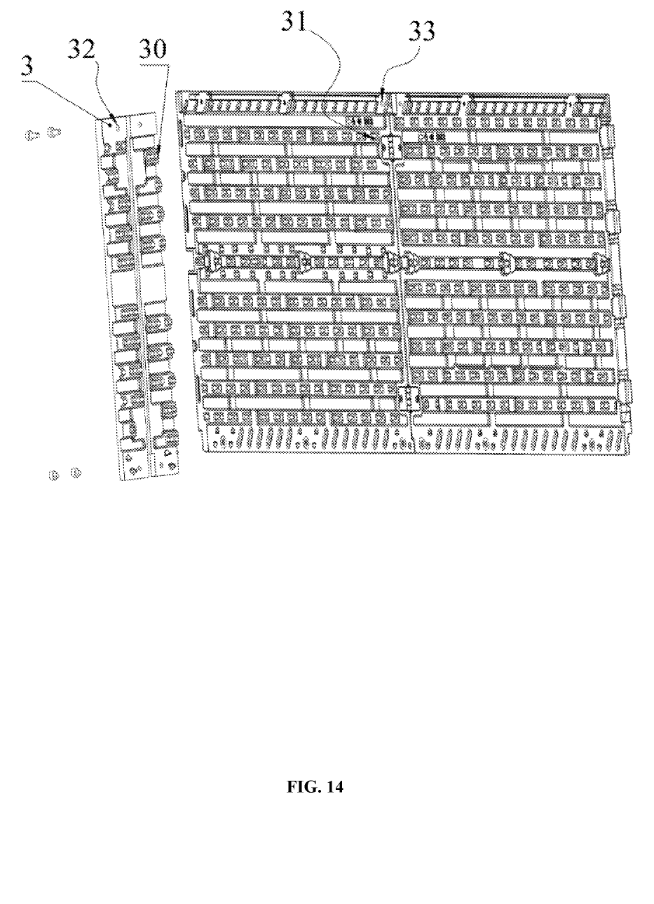

In other embodiments of the present disclosure, as shown in FIGS. 13 and 14, the connector 3 may be in the form of a pinch plate, which is a sheet-like fastening component. It is disposed on the back side of the first plastic board 1 and the back side of the second plastic board 2, spanning the splicing area between the first end 1-I of the first plastic board I and the second end 2-2 of the second plastic board 2, thereby fixing the first plastic board 1 and the second plastic board 2 into a flat, tiled integral board in the assembled state. The pinch plate and the first plastic board 1, second plastic board 2 are locked together in a detachable manner.

Specifically, the side of the pinch plate facing the back side of the first plastic board 1 and second plastic board 2 is provided with at least one positioning protrusion 30; the back sides of the first plastic board 1 and second plastic board 2, within the area covered by the pinch plate, are respectively provided with positioning grooves 31 adapted to the positioning protrusion 30. During assembly, the pinch plate is aligned with the splicing area and pressed, causing the positioning protrusion 30 to embed into the corresponding positioning groove 31, thereby achieving preliminary positioning of the pinch plate relative to the first plastic board 1 and second plastic board 2. Subsequently, bolts are used to detachably and securely connect the pinch plate to the first plastic board 1 and second plastic board 2, completing reliable locking of the two plastic boards; specifically, the pinch plate is provided with through holes 32, and the corresponding positions on the first plastic board 1 and second plastic board 2 are provided with threaded holes 33; bolts pass through the through holes 32 and are tightened into the threaded holes 33. To facilitate disassembly, the pinch plate may be provided with prying notches 34; during disassembly, the bolts are loosened in reverse, and the pinch plate is pried up through the prying notches, causing the positioning protrusion 30 to disengage from the positioning groove 31, thereby allowing the pinch plate to separate from the plastic boards and enabling separation of the two plastic boards. After removing the pinch plate, the first plastic board 1 and second plastic board 2 can be folded in any of the aforementioned overlapping manners, reducing packaging volume, and the pinch plate can be stored independently within the packaging.

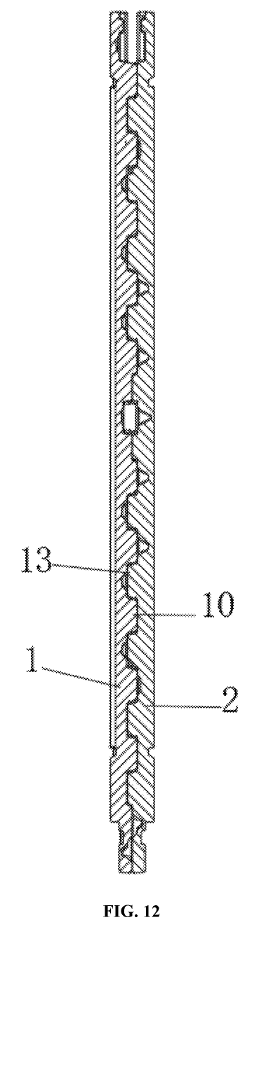

In the present disclosure, as shown in FIGS. 6 and 12, the back side or front side of the first plastic board 1 is provided with a first protrusion 10 and a first recess 11, and the back side or front side of the second plastic board 2 is provided with a second protrusion 12 adapted to the first recess 11 and a second recess 13 adapted to the first protrusion 10. The first protrusion 10 on the first plastic board 1 and the second protrusion 12 on the second plastic board 2 both provide a reinforcing effect, enhancing the strength of the plastic boards, particularly for blow-molded plastic boards.

When the first plastic board 1 and the second plastic board 2 are stacked to complete folding, the first protrusion 10 sinks into the second recess 13, and the second protrusion 12 sinks into the first recess 11. In this configuration, when the back side of the first plastic board 1 and the back side of the second plastic board 2 are attached to complete folding, the impact on increasing the folded thickness due to the presence of the first protrusion 10 and the second protrusion 12 can be reduced.

The stacking method of the first plastic board 1 and the second plastic board 2 is preferably such that when the back side of the first plastic board 1 and the back side of the second plastic board 2 are stacked, the first protrusion 10 and the first recess 11 are provided on the back side of the first plastic board 1, and the second protrusion 12 and the second recess 13 are provided on the back side of the second plastic board 2.

In other embodiments, the stacking method of the first plastic board 1 and the second plastic board 2 is such that when the front side of the first plastic board 1 and the front side of the second plastic board 2 are stacked, the first protrusion 10 and the first recess 11 are provided on the front side of the first plastic board 1, and the second protrusion 12 and the second recess 13 are provided on the front side of the second plastic board 2; or when the back side of the first plastic board 1 and the front side of the second plastic board 2 are stacked, the first protrusion 10 and the first recess 11 are provided on the back side of the first plastic board 1, and the second protrusion 12 and the second recess 13 are provided on the front side of the second plastic board 2; or when the front side of the first plastic board 1 and the back side of the second plastic board 2 are stacked, the first protrusion 10 and the first recess 11 are provided on the front side of the first plastic board 1, and the second protrusion 12 and the second recess 13 are provided on the back side of the second plastic board 2.

The above folding and attaching method ensure that when the first plastic board 1 and the second plastic board 2 are stacked to complete folding, the first protrusion 10 entirely sinks into the second recess 13, and the second protrusion 12 entirely sinks into the first recess 11, thereby allowing the first plastic board 1 to tightly adhere to the second plastic board 2, further reducing the folded volume.

In a preferred embodiment, the first protrusion 10 and the second protrusion 12 are strip-shaped ribs, and correspondingly, the first recess 11 and the second recess 13 are strip- shaped grooves. Using the matching form of strip-shaped ribs and strip-shaped grooves can more effectively achieve structural reinforcement.

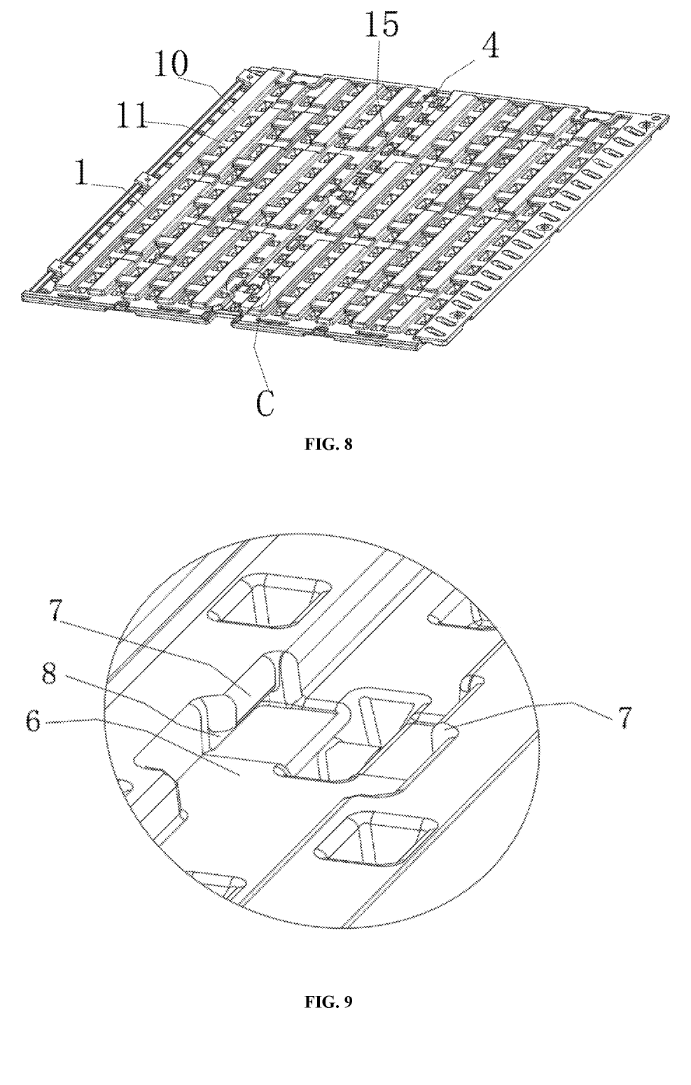

In a preferred embodiment of the present disclosure, as shown in FIGS. 8 and 10, when folded, the back side of the first plastic board 1 overlaps with the back side of the second plastic board 2. The first protrusion 10 and the first recess 11 are provided on the back side of the first plastic board 1, and the second protrusion 12 and the second recess 13 are provided on the back side of the second plastic board 2. The connector 3 is provided with a positioning opening 14, and part of the first protrusion 10 and/or the second protrusion 12 is embedded into the positioning opening 14. In this case, this part of the first protrusion and/or second protrusion serves as a positioning block 15. During assembly, the positioning block 15 is embedded into [00581 The above description is only the preferred embodiment of the present disclosure and is not intended to limit the present disclosure. For those skilled in the art, the present disclosure may have various modifications and changes. Any modifications, equivalent substitutions and improvements made within the spirit and principles of the present disclosure shall be included within the protection scope of the present disclosure. the positioning opening 14, allowing the connector 3 to be preliminarily positioned, facilitating subsequent detachable connection. The preliminary positioning method using the positioning block 15 and the positioning opening 14 can be adopted independently from or concurrently with the preliminary positioning method using the positioning slot described in the aforementioned embodiments.

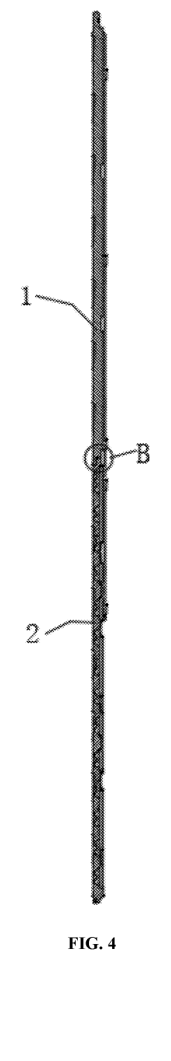

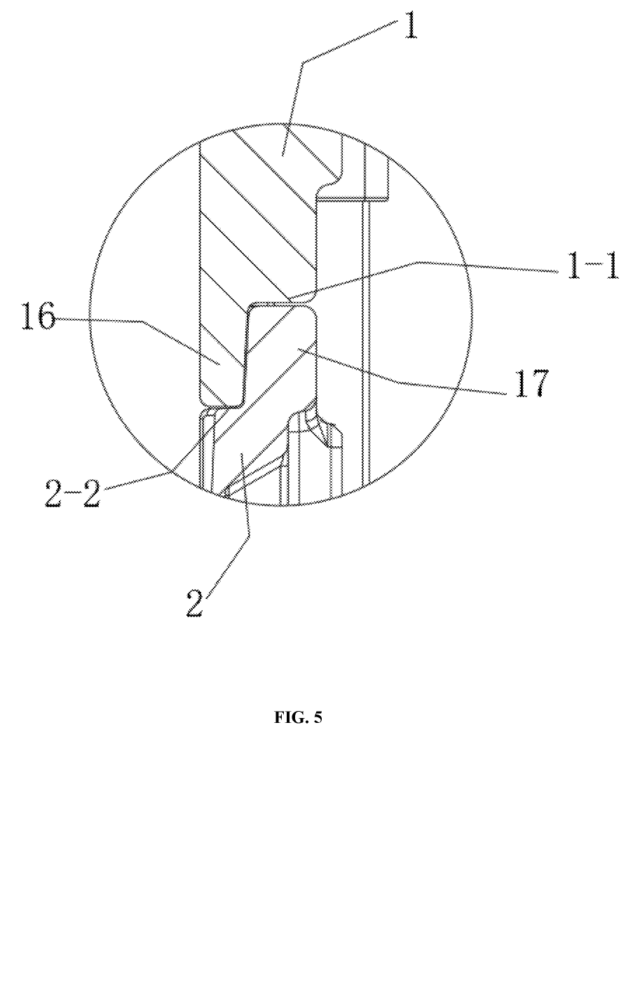

As shown in FIGS. 4 and 5, preferably, the first end 1-1 of the first plastic board has a first tongue plate 16 extending toward the second plastic board 2, and the second end 2-2 of the second plastic board has a second tongue plate 17 extending toward the first plastic board 1. The first tongue plate 16 and the second tongue plate 17 are stacked vertically. The end of the first tongue plate 16 is close to the second end 2-2 of the second plastic board, and the end of the second tongue plate 17 is close to the first end 1-1 of the first plastic board, thereby fonning a bent gap conducive to waterproofing between the end of the first tongue plate 16 and the second end 2-2 of the second plastic board, between the first tongue plate 16 and the second tongue plate 17, and between the end of the second tongue plate 17 and the first end 1-1 of the first plastic board. By forming the bent gap in this manner, when encountering humid or rainy conditions, water flows or seeps along this bent gap. The long path of flow or seepage causes the flowing water to lose kinetic energy and can only flow downward under gravity, thereby achieving a good waterproofing effect.

The plastic board connection structure of the present disclosure is particularly suitable for constituting walls or partitions of a building structure (such as American-style tool sheds, and outdoor rooms). In practical applications, a plurality ofplastic boards employing this connection structure can be sequentially spliced horizontally through the detachable connectors to form a complete wall panel unit; a plurality of wall panel units can be further secured through vertical stacking or corner connections, and can be connected to the building frame, colunns, or foundation structures, thereby modularly combining to form a stable, complete building structure. This design not only preserves the integrity and strength of large panels but also significantly reduces the volume for single transportation through split folding, achieving a balance between storage and transportation economy and on-site assembly convenience.

In summary, the present disclosure achieves the following technical effects: by replacing the traditional large-size monolithic plastic board with a detachable and connectable split design, the plastic board can be folded and stacked before transportation, effectively reducing packaging volume and footprint, significantly lowering logistics costs and requirements for handling space, while also reducing the risk of damage such as bending and scratching during transit due to oversized panels; Using detachable connectors (such as connecting rods or pinch plates) to span splicing areas, and cooperating with positioning slots, buckles, or fasteners to achieve secure locking, allows the split boards to fonn a flat, continuous overall panel surface after installation, ensuring the necessary structural strength, integrity, and flatness for wall panels, partitions and the like; this connection structure facilitates the expansion and splicing of a plurality of plastic boards in both horizontal and vertical directions, enabling efficient combination to form structural units such as walls or partitions for structures like tool sheds or outdoor rooms, achieving rapid modular assembly while maintaining overall stability and sealing of the structure; The detachable connectors allow the plastic boards to be separated and folded again when needed, facilitating storage, movement, or replacement of locally damaged panels, extending product lifespan and reducing maintenance difficulty.

In the description of the present disclosure, it should be understood that directional terms such as "front, rear, up, down, left, right," "traverse, vertical, perpendicular, horizontal "and "top, bottom,", generally refer to the orientations or positional relationships shown in the accompanying drawings. They are used merely for convenience in describing the present disclosure and simplifying the description. Unless otherwise specified, these directional terms do not indicate or imply that the device or component referred to must have a specific orientation or be constructed and operated in a specific orientation, and thus should not be construed as limiting the scope of protection of the present disclosure; The directional terms "inner, outer" refer to inside and outside relative to the contour of each component itself.

For ease of description, spatial relative tenns such as "on," "above," "on the upper surface of," "upper," may be used herein to describe the spatial relationship of one device or feature relative to other devices or features as illustrated in the drawings. It should be understood that spatial relative terms are intended to encompass different orientations of the device in use or operation, in addition to the orientation depicted in the drawings. For example, if a device in the drawings is inverted, a device described as being "above" or "on" other devices or structures would then be oriented as "below" or "under" the other devices or structures. Thus, the exemplary term "above" can encompass both "above" and "below" orientations. The device may also be oriented in other ways (rotated 90 degrees or at other orientations), and the spatial relative descriptions used herein should be interpreted accordingly.

Additionally, it should be noted that terms such as "first" and "second" are used to distinguish between components for clarity; unless otherwise stated, these terms do not imply any special meaning and should not be construed as limiting the scope of protection of the present disclosure.

The Above description is only the preferred embodiment of the present disclosure and is not intended to limit the present disclosure, Fore those skilled in the art the present disclosure may have various modifications and changes. Any modifications, equivalent substitutions and improvements made within the spirit and principles disclosure shall be included within the protection scope of the present disclosure.

What is claimed is:

1. A plastic board connection structure, comprising a first plastic board and a second plastic board, wherein the first plastic board and the second plastic board are separately arranged;
the first plastic board has a first end close to the second plastic board and a second end away from the second plastic board; the second plastic board has a first end away from the first plastic board and a second end close to the first plastic board, with the first end of the first plastic board and the second end of the second plastic board facing each other;
the plastic board connection structure further comprises a connector arranged on a back side of the first plastic board and a back side of the second plastic board, the connector being detachably connected to the back side of the first plastic board and detachably connected to the back side of the second plastic board, the connector spanning the first end of the first plastic board and the second end of the second plastic board, thereby connecting the first plastic board and the second plastic board into a tiled plate; and
after the connector is removed, the first plastic board is capable of being stacked with the second plastic board, thereby completing folding to reduce a packaging volume.

2. The plastic board connection structure according to claim 1, wherein a contour of the first plastic board is substantially the same as that of the second plastic board.

3. The plastic board connection structure according to claim 1, wherein the back side of the first plastic board and the back side of the second plastic board each have a positioning slot, and the connector is located in the positioning slot.

4. The plastic board connection structure according to claim 1, wherein the back side or a front side of the first plastic board is provided with a first protrusion and a first recess, and the back side or a front side of the second plastic board is provided with a second protrusion adapted to the first recess and a second recess adapted to the first protrusion; and
when the first plastic board and the second plastic board are stacked to complete folding, the first protrusion sinks into the second recess, and the second protrusion sinks into the first recess.

5. The plastic board connection structure according to claim 4, wherein when the first plastic board and the second plastic board are stacked to complete folding, the first protrusion entirely sinks into the second recess and the second protrusion entirely sinks into the first recess, so that the first plastic board is closely attached to the second plastic board.

6. The plastic board connection structure according to claim 5, wherein the connector is provided with a positioning opening, the first protrusion and the first recess are arranged on the back side of the first plastic board, the second protrusion and the second recess are arranged on the back side of the second plastic board, and part of the first protrusion and/or the second protrusion is embedded in the positioning opening.

7. The plastic board connection structure according to claim 4, wherein the first protrusion and the second protrusion are strip-shaped ribs, and the first recess and the second recess are strip-shaped grooves.

8. The plastic board connection structure according to claim 1, wherein the first end of the first plastic board and the second end of the second plastic board are directly opposite each other.

9. The plastic board connection structure according to claim 1, wherein the first end of the first plastic board is hinged to the second end of the second plastic board.

10. The plastic board connection structure according to claim 9, wherein the first end of the first plastic board has a first tongue plate extending toward the second plastic board, and the second end of the second plastic board has a second tongue plate extending toward the first plastic board; and
the first tongue plate and the second tongue plate are stacked vertically, an end of the first tongue plate is close to the second end of the second plastic board, and an end of the second tongue plate is close to the first end of the first plastic board, thereby forming bent gaps conducive to waterproofing between the end of the first tongue plate and the second end of the second plastic board, between the first tongue plate and the second tongue plate, and between the end of the second tongue plate and the first end of the first plastic board.

11. The plastic board connection structure according to claim 1, wherein the connector at least tightly adheres to the first end of the first plastic board and the second end of the second plastic board.

12. The plastic board connection structure according to claim 1, wherein the connector is vertically arranged on the back side of the first plastic board and the back side of the second plastic board.

13. The plastic board connection structure according to claim 12, wherein an extension length of the connector from the first end of the first plastic board to the second end of the first plastic board is at least 1/4 of a length from the first end to the second end of the first plastic board; and
an extension length of the connector from the second end of the second plastic board to the first end of the second plastic board is at least 1/4 of a length from the second end to the first end of the second plastic board.

14. The plastic board connection structure according to claim 13, wherein the connector extends from the first end of the first plastic board to a position adjacent to the second end of the first plastic board; and
an end of the connector adjacent to the second end of the first plastic board is provided with a connection cavity.

15. The plastic board connection structure according to claim 1, wherein the connector is a connecting rod, and the connecting rod and the first plastic board, and the connecting rod and the second plastic board are both connected by detachable fasteners.

16. The plastic board connection structure according to claim 15, wherein the connecting rod is a metal rod.

17. The plastic board connection structure according to claim 15, wherein the fasteners are several buckles, and the buckles clasp onto the connecting rod and are snap-connected to the first plastic board and the second plastic board.

18. The plastic board connection structure according to claim 17, wherein the back side of the first plastic board and the back side of the second plastic board are both provided with snap grooves, both sides of each snap groove are provided with baffle plates, and an interlayer is formed between the baffle plate and a bottom surface of the snap groove; and
the buckle is configured as a clip with an opening, and the connecting rod is clamped in the clip; and
two outer sides of the clip are provided with locking wings, and the locking wings slide into the interlayer so that the locking wings are locked into the interlayer.

19. The plastic board connection structure according to claim 18, wherein the connecting rod has a rectangular cross-section;
the clip comprises a first side clamping plate, a second side clamping plate, and a bottom plate connecting the first side clamping plate and the second side clamping plate, and the connecting rod is clamped in a clamping port enclosed by the first side clamping plate, the second side clamping plate, and the bottom plate; and
the locking wings are respectively provided on an outer side of the first side clamping plate and an outer side of the second side clamping plate.

20. The plastic board connection structure according to claim 1, wherein the plastic board connection structure is configured to form walls or partitions of a building, a plurality of plastic boards spliced by the connector form a wall panel unit, and a plurality of wall panel units are combined to form a complete building structure.
